(19) United States
(12) Patent Application Publication
(10) Pub. No.: US 2020/0310203 A1
(43) Pub. Date: Oct. 1, 2020

(54) PIXEL STRUCTURE OF DISPLAY

(71) Applicant: WUHAN CHINA STAR OPTOELECTRONICS TECHNOLOGY CO., LTD, Wuhan, Hubei (CN)

(72) Inventors: Chao WANG, Wuhan, Hubei (CN); Xindong MEI, Wuhan, Hubei (CN)

(21) Appl. No.: 16/613,433

(22) PCT Filed: Jan. 16, 2019
(86) PCT No.: PCT/CN2019/072027

§ 371 Date: Nov. 14, 2019

(30) Foreign Application Priority Data
Sep. 28, 2018 (CN) 201811139431.0

(51) Int. Cl. G02F 1/1343; G02F 1/1333

(52) U.S. Cl. CPC G02F 1/134363; G02F 2001/133397; G02F 1/133345

(57) ABSTRACT

A pixel structure of a display is disclosed, and includes: a first pixel region and a second pixel region adjacent to the first pixel region. The first pixel region has a first direct-current (DC) residual electric field, the second pixel region has a second DC residual electric field, and a direction of the first DC residual electric field and a direction of the second DC residual electric field are opposite to each other. An alternating electrode structure design is adopted to reduce or eliminate residual ions accumulated between the insulating layer and the electrodes, thereby reducing or eliminating an image-sticking phenomenon.

### FIELD OF INVENTION

The present invention relates to a pixel structure of a display, and more particularly, to the pixel structure of a display for optimizing image-sticking.

### BACKGROUND OF INVENTION

In recent years, as the innovation and development of display technology, application scenarios of displays have become more diverse. In some application scenarios where it is necessary to display a static picture for a long time, an image-sticking phenomenon occurs when a display switches an image, which affects the display effect and consumers' impression. The main reason of the image-sticking phenomenon is the presence of parasitic capacitance in thin film transistors (TFTs) of a liquid crystal display driving circuit. If voltage of an upper electrode plate and a lower electrode plate of the liquid crystal is kept constant for a long time, the movable ions remaining in liquid crystal molecules tend to accumulate at the same side of the liquid crystal molecules in a same direction of an electric field to form an internal electric field, when the image of the liquid crystal display is switched from a high gray level to a low gray level, the internal electric field and the electric field of the upper electrode plate and the lower electrode plate of the liquid crystal neutralize each other, so that the liquid crystal cannot reach the expected orientation, and finally the image-sticking phenomenon occurs. The parasitic capacitance of the liquid crystal panel is limited by the process and structure, thickness of a depositing insulating layer, and the difference in resistance that may cause different parasitic capacitance, and is not easy to be improved by the process.

TECHNICAL PROBLEM: In the conventional art, a flicker value of the display screen of the liquid crystal display can be used as an evaluation for measuring whether a direct-current (DC) residual effect is serious. The reason is that the voltage difference between a voltage of the positive or negative electrode which is driven by an alternating current (AC) and the common electrode voltage is not equal. If the polarity of a data line is reversed, the brightness of the screen will be changed, resulting that the screen flickers, a flicker degree of the screen depends on the critical flicker fusion frequency. A larger value of critical flicker fusion frequency results in a more serious DC residual effect. The image-sticking problem can be improved by minimizing a flicker signal to adjust an appropriate driving voltage parameter, thereby reducing a residual electric charge which is accumulated in the display panel. Moreover, there are different electric loads between different liquid crystal panels due to the process tolerance, results that the liquid crystal panels have different feed-through voltages. If a known common voltage adjustment method is used for improving the image-sticking problem, an uneven flicker may occur. Furthermore, if a known method by adjusting the common voltage through a variable resistor is used, it is necessary to rely on an operator to visually adjust the flicker. However, different operators have different sensitivity to the flicker, which results in different standards for determining the flicker, and it will cost a lot of labor costs that operators visually adjust the flicker, which results in uneven performance and quantity, and high cost.

Therefore, it is necessary to provide a pixel structure of a display to solve the problems of the conventional art.

### SUMMARY OF INVENTION

In view of the above, the present invention is to provide a pixel structure of a display to solve the problem of the conventional art that parasitic capacitance existing in the liquid crystal display causes image-sticking.

A main object of the present invention is to provide a pixel structure of a display which can improve the problem of image-sticking phenomenon.

A secondary object of the present invention is to provide a pixel structure of a display which can provide an alternating common electrode and pixel electrode design to reduce or eliminate residual ions accumulated between the insulating layer and the electrode, thereby reducing or eliminating image-sticking phenomenon.

In order to achieve the foregoing object of the present invention, an embodiment of the present invention provides a pixel structure of a display, including: a first pixel region, the pixel structure in the first pixel region including: a first electrode; an insulating protective layer disposed on the first electrode; a second electrode disposed on the insulating protective layer; and an insulating layer disposed on the second electrode; and a second pixel region adjacent to the first pixel region, the pixel structure in the second pixel region including the first electrode, the insulating protective layer, the second electrode, and the insulating layer, wherein the insulating protective layer is disposed on the second electrode, the first electrode is disposed on the insulating protective layer, and the insulating layer is disposed on the first electrode; wherein the insulating layer in the first pixel region has a first ionic polarity, and the insulating layer in the second pixel region has a second ionic polarity, the first ionic polarity and the second ionic polarity are opposite to each other, and a plurality of first ions with the first ionic polarity and a plurality of second ions with the second ionic polarity are redistributed and diffused, or neutralized by the insulating layer.

In an embodiment of the invention, the first ionic polarity is negative, and the second ionic polarity is positive.

In an embodiment of the invention, the first electrode is a common electrode, and the second electrode is a pixel electrode.

In an embodiment of the invention, the insulating layer in the first pixel region is in contact with the second electrode and the insulating layer in the second pixel region is in contact with the first electrode.

In an embodiment of the invention, the insulating layer is a polyimide layer.

In an embodiment of the invention, the common electrode in the first pixel region and the pixel electrode in the second pixel region are located in a same layer; and the pixel electrode in the first pixel region and the common electrode in the second pixel region are located in a same layer.

Moreover, the present invention is to provide a pixel structure of a display, including: a first pixel region; and a second pixel region adjacent to the first pixel region, wherein the first pixel region has a first direct-current (DC) residual electric field, and the second pixel region has a second direct-current (DC) residual electric field, a direction of the first direct-current (DC) residual electric field and a direction of the second direct-current (DC) residual electric field are opposite to each other, and a plurality of first ions with the first direct-current (DC) residual electric field and a plurality of second ions with the second direct-current (DC) residual electric field are redistributed and diffused, or neutralized by an insulating layer.

In an embodiment of the invention, the pixel structure in the first pixel region includes: a first electrode; a second electrode disposed on the first electrode; and the insulating layer disposed on the second electrode; wherein the pixel structure in the second pixel region includes: the second electrode; the first electrode disposed on the second electrode; and the insulating layer disposed on the first electrode.

In an embodiment of the invention, the first electrode is a common electrode, and the second electrode is a pixel electrode.

In an embodiment of the invention, the insulating layer in the first pixel region is in contact with the second electrode and the insulating layer in the second pixel region is in contact with the first electrode.

In an embodiment of the invention, the insulating layer is a polyimide layer.

In an embodiment of the invention, the first electrode in the first pixel region and the second electrode in the second pixel region are located in a same layer; and the second electrode in the first pixel region and the first electrode in the second pixel region are located in a same layer.

BENEFICIAL EFFECT: Compared with the conventional art, the pixel structure of the display according to the present invention can not only improve the problem that image-sticking caused by parasitic capacitance in the liquid crystal display, but also can adjust the flicker without relying on the operator's visual observation, so that the labor cost that the operator adjusts the flicker is saved, so as to improve performance and quality of the product.

### DRAWINGS

In order to more clearly illustrates the context of the present invention, the preferred embodiments are described below, and in conjunction with the accompanying drawings, the detailed description is as follows:

In the drawings:

FIG. 1 is a schematic view showing a pixel structure of a display according to a first embodiment of the present invention.

### DETAILED DESCRIPTION OF EMBODIMENTS

The following description of the various embodiments is provided to illustrate the specific embodiments of the present invention. Furthermore, the directional terms mentioned in the present invention, such as upper, lower, top, bottom, front, rear, left, right, inner, outer, side, surrounding, central, horizontal, horizontal, vertical, longitudinal, axial, radial, uppermost or lowermost, etc., only refer to the direction of the accompanying drawings. Therefore, the directional terminology used is for the purpose of illustration and understanding of the present invention.

The term “image-sticking” as used herein refers to a phenomenon that a display shows a still image for a long time and leaves the previous image after changing the display content.

The term “pixel region” as used herein refers to a basic unit of a display image in a display. A pixel region is usually a square in design, and the square pixel is divided into three color units of red, green and blue.

The terms “a”, “an” and “the” as used herein includes multiple references unless the context clearly dictates otherwise. For example, the term “an electrode” or “at least one electrode” can include a plurality of electrodes, including compositions thereof.

The sizes and values disclosed herein are not intended to be construed as being strictly limited to the precise values. On the contrary, unless otherwise indicated, various sizes are intended to represent the recited numerical values as well as the functionally equivalent ranges thereof. For example, the disclosed size of “10 microns” means “about 10 microns.”

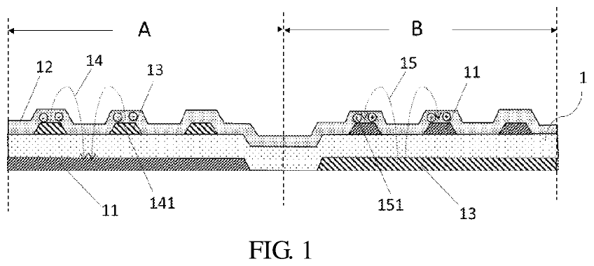

Please refer to FIG. 1, in order to achieve the foregoing objects of the present invention, a pixel structure 1 of a display, such as a pixel structure applied on array substrates as thin film transistor (TFT) displays, is provided. The pixel structure 1 includes: a first pixel region A and a second pixel region B. The pixel structure 1 which is in the first pixel region A includes: a first electrode 11, an insulating protective layer 12, and an insulating layer 14. In this embodiment, the first electrode 11 is a common electrode; the insulating protective layer 12 is disposed on the first electrode 11; the second electrode 13 is disposed on the insulating protective layer 12. In this embodiment, the second electrode 13 is a pixel electrode, and the insulating layer 14 is disposed on the second electrode 13. In this embodiment, the insulating layer 14 is a polyimide layer. The second pixel region B is adjacent to the first pixel region A, and the pixel structure 1 which is in the second pixel region B includes the first electrode 11, the insulating protective layer 12, the second electrode 13, and the insulating layer 14. The insulating protective layer 12 is disposed on the second electrode 13, the first electrode 11 is disposed on the insulating protective layer 12, and the insulating layer 14 is disposed on the first electrode 11. In other words, an arrangement of the first electrode 11 and the second electrode 13 in the first pixel region A and an arrangement of the first electrode 11 and the second electrode in the second pixel region B is opposite to each other. Therefore, the insulating layer 14 in the first pixel region A has a first ionic polarity 15, and the insulating layer 14 in the second pixel region B has a second ionic polarity 16, the first ionic polarity 15 and the second ionic polarity 16 are opposite to each other. Preferably, the first ionic polarity 15 is negative and the second ionic polarity 16 is positive.

Preferably, as shown in FIG. 1, the insulating layer 14 in the first pixel region A is in contact with the second electrode 13, and the insulating layer 14 in the second pixel region B is in contact with the first electrode 11. Preferably, as shown in FIG. 1, the common electrode in the first pixel region A and the pixel electrode in the second pixel region B are located in a same layer. The pixel electrode in the first pixel region A and the common electrode in the second pixel region B are located in a same layer. A plurality of first ions 151 with the first ion polarity 15 and a plurality of second ions 161 with the second ion polarity 16 are redistributed and diffused by the insulating layer 14 to reduce or neutralize the first ions 151 remaining in the first pixel region A and the second ions 161 remaining in the second pixel region B.

Moreover, another embodiment of the present invention further provides a pixel structure similar to the display described above, including: a first pixel region and a second pixel region adjacent to the first pixel region. The pixel structure which is in the first pixel region includes: a first electrode, a second electrode, and an insulating layer, the second electrode disposed on the first electrode, and the insulating layer is disposed on the second electrode. The pixel structure in the second pixel region includes: the second electrode, the first electrode, and the insulating layer, the first electrode disposed on the second electrode, and the insulating layer is disposed on the first electrode. Preferably, the first electrode is a common electrode, and the second electrode is a pixel electrode. Preferably, the insulating layer is a polyimide layer. The first pixel region has a first direct-current (DC) residual electric field, the second pixel region has a second direct-current (DC) residual electric field, and a direction of the first direct-current (DC) residual electric field and a direction of the second direct-current (DC) residual electric field are opposite to each other. The insulating layer in the first pixel region is in contact with the second electrode and the insulating layer in the second pixel region is in contact with the first electrode; such that the first direct-current (DC) residual electric field and the second direct-current (DC) residual electric field are redistributed and diffused by the insulating layer, thereby reducing or neutralizing the first DC residual electric field in the first pixel region and the second DC residual electric field in the second pixel region. A plurality of first ions with the first DC residual electric field and a plurality of second ions with the second DC residual electric field is distributed or neutralized by the insulating layer.

As described above, although the image-sticking problem can be improved by adjusting the common voltage in the existing method, there are different electric loads between different liquid crystal panels due to the process tolerance, results that the liquid crystal panels have different feed-through voltages, as a result, different feed-through voltages cause an uneven flicker of the liquid crystal panel. Moreover, if a known method by adjusting the common voltage through a variable resistor is used, it is necessary to rely on an operator to visually adjust the flicker. However, different operators have different sensitivity to flicker, which results in different standards for determining the flicker, and it will cost a lot of labor costs that operators visually adjust the flicker, and results in the drawbacks, such as uneven performance and quantity, and high cost. The pixel structure of the display, according to the present invention, is to provide an alternating common electrode and a pixel electrode design between the adjacent pixel regions, it can effectively reduce or eliminate the residual ions accumulated between the insulating layer and the electrode, thereby reducing or eliminating the image-sticking phenomenon, thereby improving the performance and quality of the product.

The present invention has been described by the above related embodiments, but the above embodiments are merely examples for implementing the present invention. It must be noted that the disclosed embodiments are not intended to limit the scope of the present invention. Conversely, modifications and equivalent arrangements are intended to be included within the scope of the present invention.

1. A pixel structure of a display, comprising:
a first pixel region, the pixel structure in the first pixel region comprising:
a common electrode;
an insulating protective layer disposed on the common electrode;
a pixel electrode disposed on the insulating protective layer; and
an insulating layer disposed on the pixel electrode; and
a second pixel region adjacent to the first pixel region, the pixel structure in the second pixel region comprising the common electrode, the insulating protective layer, the pixel electrode, and the insulating layer, wherein the insulating protective layer is disposed on the pixel electrode, the common electrode is disposed on the insulating protective layer, and the insulating layer is disposed on the common electrode;
wherein the insulating layer in the first pixel region has a first ionic polarity, and the insulating layer in the second pixel region has a second ionic polarity, the first ionic polarity and the second ionic polarity are opposite to each other, and a plurality of first ions with the first ionic polarity and a plurality of second ions with the second ionic polarity are redistributed and diffused, or neutralized by the insulating layer.

2. The pixel structure of the display according to claim 1, wherein the first ionic polarity is negative, and the second ionic polarity is positive.

3. The pixel structure of the display according to claim 1, wherein the insulating layer in the first pixel region is in contact with the pixel electrode and the insulating layer in the second pixel region is in contact with the common electrode.

4. The pixel structure of the display according to claim 1, wherein the insulating layer is a polyimide layer.

5. The pixel structure of the display according to claim 1, wherein the common electrode in the first pixel region and the pixel electrode in the second pixel region are located in a same layer; and the pixel electrode in the first pixel region and the common electrode in the second pixel region are located in a same layer.

6. A pixel structure of a display, comprising:
a first pixel region, the pixel structure in the first pixel region comprising:
a first electrode;
an insulating protective layer disposed on the first electrode;
a second electrode disposed on the insulating protective layer; and
an insulating layer disposed on the second electrode; and
a second pixel region adjacent to the first pixel region, the pixel structure in the second pixel region comprising the first electrode, the insulating protective layer, the second electrode, and the insulating layer, wherein the insulating protective layer is disposed on the second electrode, the first electrode is disposed on the insulating protective layer, and the insulating layer is disposed on the first electrode;
wherein the insulating layer in the first pixel region has a first ionic polarity, and the insulating layer in the second pixel region has a second ionic polarity, and the first ionic polarity and the second ionic polarity are opposite to each other.

7. The pixel structure of the display according to claim 6, wherein the first ionic polarity is negative and the second ionic polarity is positive.

8. The pixel structure of the display according to claim 6, wherein the first electrode is a common electrode, and the second electrode is a pixel electrode.

9. The pixel structure of the display according to claim 6, wherein the insulating layer in the first pixel region is in contact with the second electrode and the insulating layer in the second pixel region is in contact with the first electrode.

10. The pixel structure of the display according to claim 6, wherein the insulating layer is a polyimide layer.

11. The pixel structure of the display according to claim 8, wherein the first electrode in the first pixel region and the second electrode in the second pixel region are located in a same layer; and the second electrode in the first pixel region and the first electrode in the second pixel region are located in a same layer.

12. A pixel structure of a display, comprising:
a first pixel region; and
a second pixel region adjacent to the first pixel region,
wherein the first pixel region has a first direct-current (DC) residual electric field, and the second pixel region has a second direct-current (DC) residual electric field, a direction of the first direct-current (DC) residual electric field and a direction of the second direct-current (DC) residual electric field are opposite to each other, and a plurality of first ions with the first direct-current (DC) residual electric field and a plurality of second ions with the second direct-current (DC) residual electric field are redistributed and diffused, or neutralized-by an insulating layer.

13. The pixel structure of the display according to claim 12, wherein the pixel structure in the first pixel region comprises:
a first electrode;
a second electrode disposed on the first electrode; and
the insulating layer disposed on the second electrode;
wherein the pixel structure in the second pixel region comprises:
the second electrode;
the first electrode disposed on the second electrode; and
the insulating layer disposed on the first electrode.

14. The pixel structure of the display according to claim 13, wherein the first electrode is a common electrode, and the second electrode is a pixel electrode.

15. The pixel structure of the display according to claim 13, wherein the insulating layer in the first pixel region is in contact with the second electrode and the insulating layer in the second pixel region is in contact with the first electrode.

16. The pixel structure of the display according to claim 13, wherein the insulating layer is a polyimide layer.

17. The pixel structure of the display according to claim 14, wherein the first electrode in the first pixel region and the second electrode in the second pixel region are located in a same layer; and the second electrode in the first pixel region and the first electrode in the second pixel region are located in a same layer.
